(19) United States
(12) Patent Application Publication
(10) Pub. No.: US 2010/0107058 A1
(43) Pub. Date: Apr. 29, 2010

(54) QUERY AWARE PROCESSING

(75) Inventors: Aravindan RAGHUVEER, Bangalore (IN); Venkatavardhan RAGHUNATHAN, Bangalore (IN)

Correspondence Address: Evergreen Valley Law Group, P.C. and Yahoo! Inc., 4 South Second Street, Suite 598, San Jose, CA, 95113, US

(73) Assignee: YAHOO! INC., Sunnyvale, CA (US)

(21) Appl. No.: 12/256,475

(22) Filed: Oct. 23, 2008

(51) Int. Cl. G06F 17/27; G06F 17/30

(52) U.S. Cl. 715/237; 707/E17.069; 707/E17.129; 707/E17.131

(57) ABSTRACT

Query aware processing. An example method of processing mark-up language documents includes receiving a plurality of conditions and desired output format from a plurality of clients, and a mark-up language document. The method also includes determining whether the mark-up language document satisfies the plurality of conditions. If the mark-up language document satisfies at least one condition of the plurality of conditions then at least one of unparsed mark-up language document, part of the unparsed mark-up language document, a document object model of the mark-up language document, and part of the document object model of the mark-up language document is provided based on the desired output format.

### BACKGROUND

Over a period of time, the use of mark-up language documents, for example Extensible Mark-up Language (XML) documents, has increased. Before an XML document is consumed by a consumer, the XML document is processed by checking conditions set by the consumer. The conditions can be in form of queries, for example XPath query, XQuery query or any other query. The XML document can be checked by creating a document object model (DOM) of the XML document and querying the DOM to answer the queries. If the XML document satisfies the conditions then only the XML document is used by the consumer. Often, a similar XML document may be required by multiple consumers. In such a scenario parsing the XML document and then checking respective conditions at each client end leads to duplication of effort and increases resource consumption. The network bandwidth is also utilized inefficiently. The inefficient utilization of bandwidth worsens when conditions of only a few consumers out of thousands of consumers are met and rest all consumers reject the XML document. Further, each consumer is required to implement an XML parser at its end leading to time and cost consumption.

In light of the foregoing discussion, there is a need for an efficient technique for processing mark-up language documents.

### SUMMARY

Embodiments of the present disclosure described herein provide a method, system and machine-readable medium for processing mark-up language documents.

An example method for processing mark-up language documents includes receiving a plurality of conditions and desired output format from a plurality of clients, and a mark-up language document. The method also includes determining whether the mark-up language document satisfies the plurality of conditions. If the mark-up language document satisfies at least one condition of the plurality of conditions then at least one of unparsed mark-up language document, part of the unparsed mark-up language document, a document object model of the mark-up language document, and part of the document object model of the mark-up language document is provided based on the desired output format.

An example system for processing mark-up language documents includes a communication interface for in electronic communication with a plurality of clients. The system also includes a system storage unit for storing instructions. Further, the system includes a processor for executing the instructions. The instructions are for determining if a mark-up language document satisfies a plurality of conditions specified by the plurality of clients, and providing at least one of unparsed mark-up language document, part of the unparsed mark-up language document, a document object model of the mark-up language document, and part of the document object model of the mark-up language document based on output format specified by a client, if the mark-up language document satisfies at least one condition of the client.

An example machine-readable medium for processing mark-up language documents includes instructions operable to cause a programmable processor to perform receiving a plurality of conditions and desired output format from a plurality of clients, and a mark-up language document. Further, it is determined if the mark-up language document satisfies the plurality of conditions. If the mark-up language document satisfies at least one condition of the plurality of conditions then at least one of unparsed mark-up language document, part of the unparsed mark-up language document, a document object model of the mark-up language document, and part of the document object model of the mark-up language document is provided based on the desired output format.

### BRIEF DESCRIPTION OF THE FIGURES

FIG. 1 is a block diagram of an environment in accordance with which various embodiments can be implemented;

FIG. 2 is a block diagram of a device in accordance with one embodiment; and

FIG. 3 is flowchart illustrating a method for processing mark-up language documents in accordance with one embodiment.

### DETAILED DESCRIPTION OF THE EMBODIMENTS

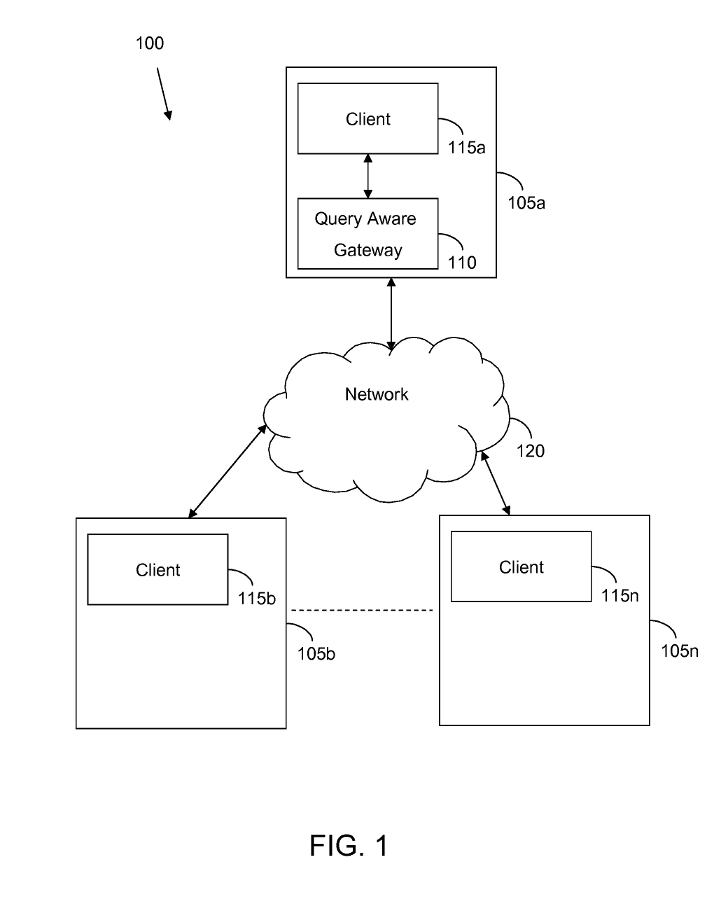

FIG. 1 is a block diagram of an environment 100, in which various embodiments of the present disclosure can be implemented. Environment 100 includes one or more devices, for example a device 105a, a device 105b and a device 105n. Examples of the devices include but are not limited to computer systems, laptops, Personal Digital Assistants (PDAs), mobiles, computing devices, handheld devices and other data processing units.

Device 105a includes a query aware gateway 110. Query aware gateway 110 receives a plurality of conditions from a plurality of clients, for example a client 115a, a client 115b and a client 115n. Device 105a can include one or more clients. Each client can specify one or more conditions. Examples of the clients include but are not limited to an application, devices, for example 105n and other possible entities from which a query can be received. Examples of the conditions include but are not limited to Extensible Mark-up Language (XML) Path Language (XPATH) queries, XQuery queries, Extensible Stylesheet Language Transformations (XSLT), Hypertext Mark-up Language (HTML) queries and keyword based queries. Query aware gateway 110 also receives a desired output format from each client.

Query aware gateway 110 receives a mark-up language document, for example an XML document. The mark-up language document can be received from a network 120, from the clients, can originate within device 105a or can be accessed from a storage unit. Query aware parser 110 determines whether the XML document satisfies the conditions. Query aware parser 110 provides the output in desired output format to the client if the XML document satisfies the conditions specified by the client.

Query aware gateway 110 can receive the conditions from the clients through network 120. The conditions are the queries specified by the clients that need to be evaluated on the mark-up language document. Examples of network 120 include but are not limited to a Local Area Network (LAN), a Wireless Local Area Network (WLAN), a Wide Area Network (WAN), internet and a Small Area Network (SAN).

Query aware gateway 110 runs a query aware processing application. The query aware processing application can be used through various serving front-ends. For example, the query aware processing application can be built as a standalone library and linked into various applications or can be exposed through a web-service to the clients or can be used as publish-subscribe system.

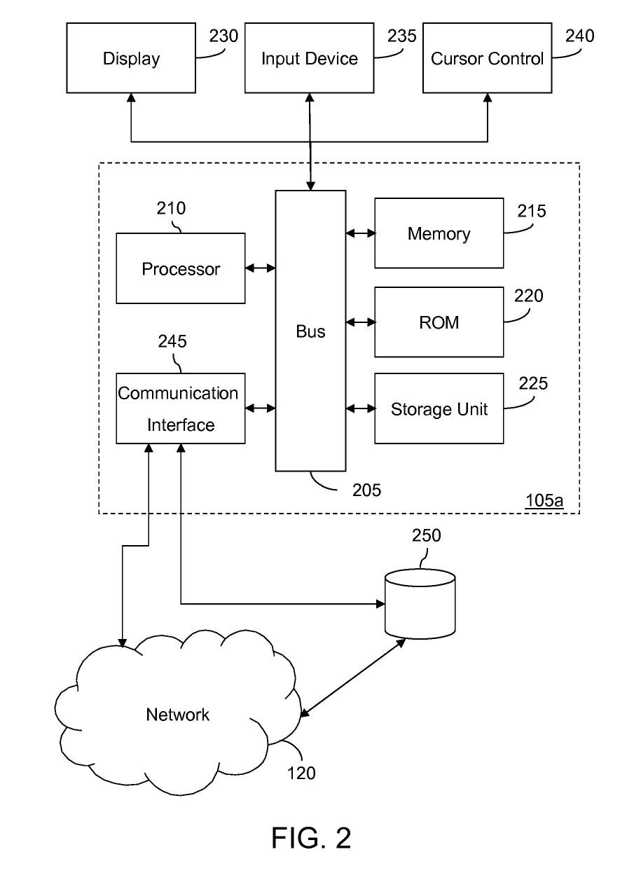

Device 105a includes a plurality of elements for processing the mark-up language document. Device 105a including the elements is explained in detail in FIG. 2.

FIG. 2 is a block diagram of device 105a in accordance with one embodiment. Device 105a includes a bus 205 or other communication mechanism for communicating information, and a processor 210 coupled with bus 205 for processing information. Device 105a also includes a memory 215, such as a random access memory (RAM) or other dynamic storage device, coupled to bus 205 for storing information and instructions to be executed by processor 210. Memory 215 can be used for storing temporary variables or other intermediate information during execution of instructions to be executed by processor 210. Device 105a further includes a read only memory (ROM) 220 or other static storage device coupled to bus 205 for storing static information and instructions for processor 210. A storage unit 225, such as a magnetic disk or optical disk, is provided and coupled to bus 205 for storing information and instructions.

Device 105a can be coupled via bus 205 to a display 230, such as a cathode ray tube (CRT), for displaying information to a user. An input device 235, including alphanumeric and other keys, is coupled to bus 205 for communicating information and command selections to processor 210. Another type of user input device is cursor control 240, such as a mouse, a trackball, or cursor direction keys for communicating direction information and command selections to processor 210 and for controlling cursor movement on display 230.

Various embodiments are related to the use of device 105a for implementing the techniques described herein. In one embodiment, the techniques are performed by device 105a in response to processor 210 executing instructions included in memory 215. Such instructions can be read into memory 215 from another machine-readable medium, such as storage unit 225. Execution of the instructions included in memory 215 causes processor 210 to perform the process steps described herein. In alternative embodiments, hard-wired circuitry can be used in place of or in combination with software instructions to implement various embodiments.

The term “machine-readable medium” as used herein refers to any medium that participates in providing data that causes a machine to operate in a specific fashion. In an embodiment implemented using device 105a, various machine-readable medium are involved, for example, in providing instructions to processor 210 for execution. The machine-readable medium can be a storage media. Storage media includes both non-volatile media and volatile media. Non-volatile media includes, for example, optical or magnetic disks, such as storage unit 225. Volatile media includes dynamic memory, such as memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that comprise bus 205. Transmission media can also take the form of acoustic or light waves, such as those generated during radio-wave and infra-red data communications. Examples of machine-readable medium may include but are not limited to a carrier wave as describer hereinafter or any other medium from which device 105a can read, for example online software, download links, installation links, and online links. For example, the instructions can initially be carried on a magnetic disk of a remote computer. The remote computer can load the instructions into its dynamic memory and send the instructions over a telephone line using a modem. A modem local to device 105a can receive the data on the telephone line and use an infra-red transmitter to convert the data to an infra-red signal. An infra-red detector can receive the data carried in the infra-red signal and appropriate circuitry can place the data on bus 205. Bus 205 carries the data to memory 215, from which processor 210 retrieves and executes the instructions. The instructions received by memory 215 can optionally be stored on storage unit 225 either before or after execution by processor 210. All such media must be tangible to enable the instructions carried by the media to be detected by a physical mechanism that reads the instructions into a machine.

Device 105a also includes a communication interface 245 coupled to bus 205. Communication interface 245 provides a two-way data communication coupling to network 120. For example, communication interface 245 can be an integrated services digital network (ISDN) card or a modem to provide a data communication connection to a corresponding type of telephone line. As another example, communication interface 245 can be a local area network (LAN) card to provide a data communication connection to a compatible LAN. Wireless links can also be implemented. In any such implementation, communication interface 245 sends and receives electrical, electromagnetic or optical signals that carry digital data streams representing various types of information.

Device 105a can receive the conditions and desired output format from the clients through communication interface 245. Device 105a can also receive the mark-up language document through communication interface 245. Device 105a can also fetch data including the conditions, the desired output format and the mark-up language document from a storage device 250. Device 105a can send messages and receive data, including program code, from storage device 250 or through network 120. Device 105a can also fetch data from memory 215 or storage unit 225.

The code can be executed by processor 210 as the code is received, or stored in storage unit 225, or other non-volatile storage for later execution.

The query aware processing application can be run using processor 210.

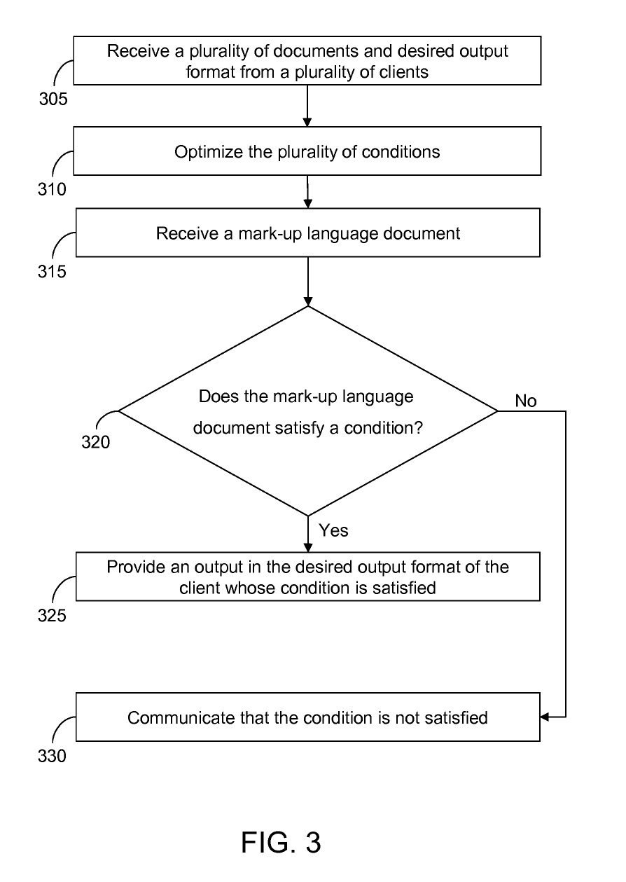

FIG. 3 is flowchart illustrating a method for processing mark-up language documents in accordance with one embodiment.

A query aware processing application running on a query aware gateway of a device receives a plurality of conditions and desired output format from a plurality of clients, at step 305. The clients can be registered with the query aware gateway. Each client can specify the desired output format that the client wants whenever a condition is satisfied. The desired output format can differ from one client to another and can also differ from one condition to another for a single client.

At step 310, the conditions are optimized. The conditions can be optimized by creating one or more rules based on the conditions. A rule can include an order in which the conditions will be evaluated. For example, for four conditions C1, C2, C3 and C4 received from different clients a rule specifying that if condition C1 is not satisfied then conditions C2, C3 and C4 will not be satisfied can be created. The condition C1 can then be evaluated first followed by other conditions if the condition C1 is met. The conditions can also be optimized by removing duplicate conditions.

At step 315, a mark-up language document is received. Examples of the mark-up language document include but are not limited to XML document and HTML document. The mark-up language document can be received from a network, from the clients, can originate within the device or can be accessed from a storage unit.

At step 320, the conditions are evaluated on the mark-up language document to determine whether the mark-up language document satisfies the conditions. The mark-up language document is queried based on the rules created during optimization of the conditions. The mark-up language document is parsed and the conditions can be evaluated one by one or simultaneously on the mark-up language document. The conditions can be evaluated by constructing a document object model (DOM) for the mark-up language document and running the queries using the DOM. The parsing can also be evaluated using Simple API for XML (SAX) events.

In some embodiments, the incoming conditions can also be updated automatically if they are capable of being evaluated on the mark-up language document while the evaluation is going on for previously received conditions.

For each condition that is satisfied at step 320, output is provided in the format specified by the corresponding client at step 325. The desired output format can include at least one of unparsed mark-up language document, part of the unparsed mark-up language document, the DOM of the mark-up language document or part of the DOM of the mark-up language document. The output can include the DOM of the mark-up language document or part of the DOM of the mark-up language document if the client and the query aware gateway use a similar technology. For example, if the client and the query aware gateway support Java then a Java based DOM or part of the Java based DOM satisfying the condition can be provided. Some clients can also specify only a communication indicating that the condition is met.

For each condition that is not satisfied at step 320, a communication indicating that the condition is not satisfied is sent to the corresponding client at step 330. In some embodiments, if a default is set then the mark-up language document can be provided to the client even if the condition is not satisfied.

Various embodiments provide a query aware gateway for query aware processing which reduces duplication of parsing at various clients and reduces bandwidth usage. Further, providing output in the desired output format satisfies client and increases richness of output.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A computer-implemented method for processing mark-up language documents, the computer-implemented method comprising:
receiving, electronically in a computer, a plurality of conditions and desired output format from a plurality of clients, and a mark-up language document;
determining if the mark-up language document satisfies the plurality of conditions; and
providing electronically at least one of:
unparsed mark-up language document;
part of the unparsed mark-up language document;
a document object model of the mark-up language document; and
part of the document object model of the mark-up language document based on the desired output format, if the mark-up language document satisfies at least one condition of the plurality of conditions.

2. The computer-implemented method of claim 1, wherein the determining comprises:
parsing the mark-up language document.

3. The computer-implemented method of claim 1, wherein the determining comprises:
creating the document object model from the mark-up language document.

4. The computer-implemented method of claim 1, wherein the determining comprises:
optimizing the plurality of conditions.

5. The computer-implemented method of claim 4, wherein the optimizing comprises:
creating one or more rules from the plurality of conditions; and
querying the mark-up language document based on the one or more rules.

6. The computer-implemented method of claim 1, wherein the providing comprises:
communicating to the plurality of clients whether corresponding conditions are satisfied or not.

7. The computer-implemented method of claim 1, wherein the mark-up language document comprises an extensible mark-up language document (XML).

8. The computer-implemented method of claim 1, wherein the plurality of conditions comprises at least one of an extensible mark-up language (XML) path query, an XML query, an XQuery query and keyword based query.

9. A system for processing mark-up language documents, the system comprising:
a communication interface in electronic communication with a plurality of clients;
a memory for storing instructions; and
a processor for executing the instructions, the instructions for:
determining if a mark-up language document satisfies a plurality of conditions specified by the plurality of clients; and
providing at least one of:
unparsed mark-up language document;
part of the unparsed mark-up language document;
a document object model of the mark-up language document; and
part of the document object model of the mark-up language document based on output format specified by a client, if the mark-up language document satisfies at least one condition of the client.

10. A machine-readable medium for processing mark-up language documents, the machine-readable medium comprising instructions operable to cause a programmable processor to perform:
receiving a plurality of conditions and desired output format from a plurality of clients, and a mark-up language document;
determining if the mark-up language document satisfies the plurality of conditions; and
providing at least one of:
unparsed mark-up language document;
part of the unparsed mark-up language document;
a document object model of the mark-up language document; and
part of the document object model of the mark-up language document based on the desired output format, if the mark-up language document satisfies at least one condition of the plurality of conditions.

11. The machine-readable medium of claim 10, wherein the determining comprises:
parsing the mark-up language document.

12. The machine-readable medium of claim 10, wherein the determining comprises:
creating the document object model from the mark-up language document.

13. The machine-readable medium of claim 10, wherein the determining further comprises:
optimizing the plurality of conditions.

14. The computer machine-readable medium of claim 13, wherein the optimizing comprises:
creating one or more rules from the plurality of conditions; and
querying the mark-up language document based on the one or more rules.

15. The machine-readable medium of claim 10, wherein the providing comprises:
communicating to the plurality of clients whether corresponding conditions are satisfied or not.

16. The machine-readable medium of claim 10, wherein the mark-up language document comprises an extensible mark-up language document (XML).

17. The machine-readable medium of claim 10, wherein the plurality of conditions comprises at least one of an extensible mark-up language (XML) path query, an XML query, an XQuery query and keyword based query.
